(19) United States
(12) Patent Application Publication
(10) Pub. No.: US 2012/0315593 A1
(43) Pub. Date: Dec. 13, 2012

(54) ADJUSTABLE ORTHODONTIC BRACKET

(75) Inventors: Alejandro Ramos-de-la-Peña, Monterrey (MX); Pedro-Nicolás Menchaca-Flores, Monterrey (MX)

(73) Assignee: ASOCIACION METROPOLITANA PARA LA EDUCACION, Monterrey (MX)

(21) Appl. No.: 13/159,113

(22) Filed: Jun. 13, 2011

(51) Int. Cl. A61C 7/16; A61C 7/14

(52) U.S. Cl. 433/9; 433/8

(57) ABSTRACT

An adjustable orthodontic bracket comprising: a fixed support base having a circular housing and an inferior surface for attaching to the surface of a tooth; a rotating base, rotary housed inside the circular housing, having a superior surface for receiving a bracket; and locking means for the rotating base, for locking the rotary movement of the base at a specific rotational position, wherein said locking means can be disabled to allow the rotation of the rotating base.

### BACKGROUND OF THE INVENTION

A. Field of the Invention

The present invention is related with orthodontic brackets and more particularly to an adjustable orthodontic bracket which can be rotated to adjust the position of the bracket with respect to the orthodontic wires and facilitate the insertion of the wire in the bracket and which has means for locking the bracket in a specific rotating angle.

B. Description of the Related Art

Orthodontic brackets are well known in the art, which are cemented onto the front side of the teeth for receiving a wire under tension and serve as force transmitter for moving or aligning the teeth until an adequate esthetic and functional position is achieved.

Most common bracket designs are set at a specific position, so that the insertion of the wire into the bracket is complicated as the teeth move from its original position since the channel that receives the wire is not always aligned with the wire.

In order to overcome the above referred problem, there have been developed several designs of brackets capable of rotate over its own axis in order to align their channels with the wire and facilitate its insertion in the brackets.

Examples of such designs are disclosed in U.S. Pat. Nos. 4,597,739 and 4,867,678, each describing a specific bracket design generally comprising a fixed portion and a rotary portion joined to the fixed portion.

However in said designs, the rotary portion of the bracket can freely rotate, since they lack means for restricting the movement of the rotary portion or means for locking the rotary portion, which is necessary during specific stages of an orthodontic treatment or in specific orthodontic treatments.

U.S. Pat. No. 7,306,458 also discloses an adjustable bracket comprising a fixed portion and a rotary portion. Additionally it comprises means for restricting the movement of the rotary portion, however, said means are not able to completely restrict the movement of the rotary portion and therefore it can rotate if sufficient force is applied.

In view of the above problems and of the necessity of providing an adjustable bracket having blocking means for the rotary portion for locking it in a predetermined angular position and avoid its rotary movement, applicant developed and adjustable bracket having locking means which can be unlocked by using any adequate tool.

In the adjustable bracket of the present invention, the rotary portion of the bracket can be adjusted at specific rotary angular positions in order to align the bracket with the wire, fix the rotary portion in said rotary angular position by means of the blocking means and facilitate its insertion thereof for an optimum effectiveness of the orthodontic treatment.

### SUMMARY OF THE INVENTION

It is therefore a main object of the present invention to provide an adjustable bracket having blocking means for the rotary portion for locking it in a predetermined angular position and avoid its rotary movement.

It is another objet of the present invention to provide an adjustable bracket of the above referred nature having locking means which can be unlocked by using any adequate tool.

It is still another objet of the present invention to provide an adjustable bracket of the above referred nature in which the rotary portion of the bracket can be adjusted at specific rotary angular positions in order to align the bracket with the wire, fix the rotary portion in said rotary angular position by means of the blocking means and facilitate its insertion thereof for an optimum effectiveness of the orthodontic treatment.

These and other objects and advantages of the adjustable orthodontic bracket of the present invention, will be clear enough to those persons having ordinary skill in the art, from the following detailed description of the embodiments of the invention, which will be disclosed with reference to the accompanied drawings and which will be within the true scope of the present invention.

### BRIEF DESCRIPTION OF THE DRAWINGS

FIG. 1 is a perspective view of the support base of the adjustable orthodontic bracket of the present invention including the locking means.

FIG. 2 is an inferior view of the support base of the adjustable orthodontic bracket of the present invention.

FIG. 3 is another perspective view of the support base of the adjustable orthodontic bracket of the present invention including the locking means showing.

FIG. 4 is yet another a perspective view of the support base of the adjustable orthodontic bracket of the present invention including the locking means.

FIG. 5 is a perspective view of the cross section of the retention housing of the locking means showing its components.

FIG. 6 is a perspective view of the cross section of the circular base, of the rotary base and of the retention housing of the locking means showing its components.

FIG. 7 is a perspective view of the rotary base including the locking piston of the locking means and a lower view of the circular base including the rotary base.

FIG. 8 is a perspective view of the rotary base including a bracket and of the circular base, showing the place where the rectangular protrusion is slidable housed.

FIG. 9 is a view of the cross section of the rotary base including the spring and the pellet.

FIG. 10 is another perspective view of the rotary base including the locking piston of the locking means.

FIG. 11 is a perspective view of the adjustable orthodontic bracket of the present invention.

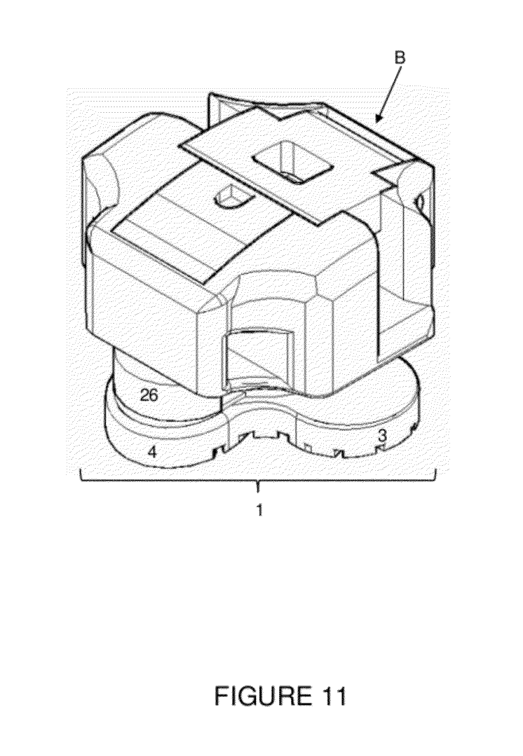

### DETAILED DESCRIPTION OF THE INVENTION

The adjustable orthodontic bracket of the present invention will be described with reference to the accompanying drawings, using reference numbers to identify the constitutive parts of the system, shown in the drawings which illustrate the preferred embodiments of the invention, wherein the adjustable orthodontic bracket of the present invention comprising:

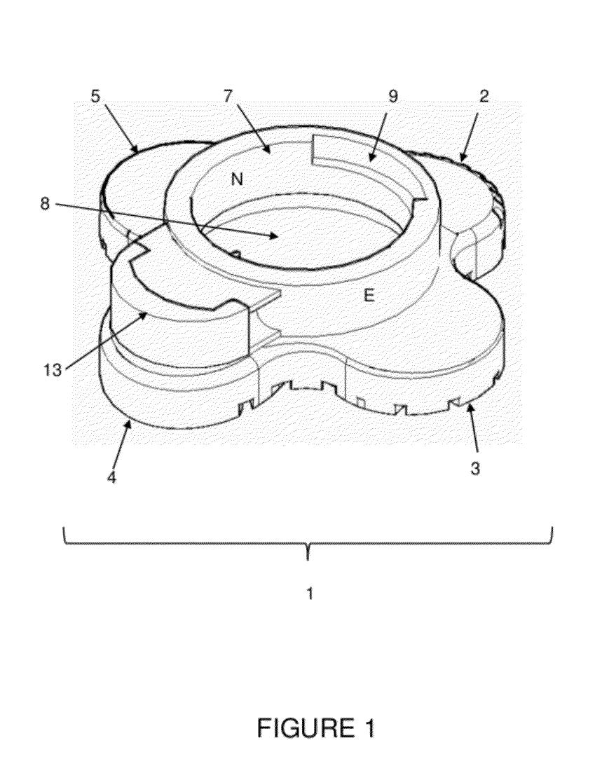

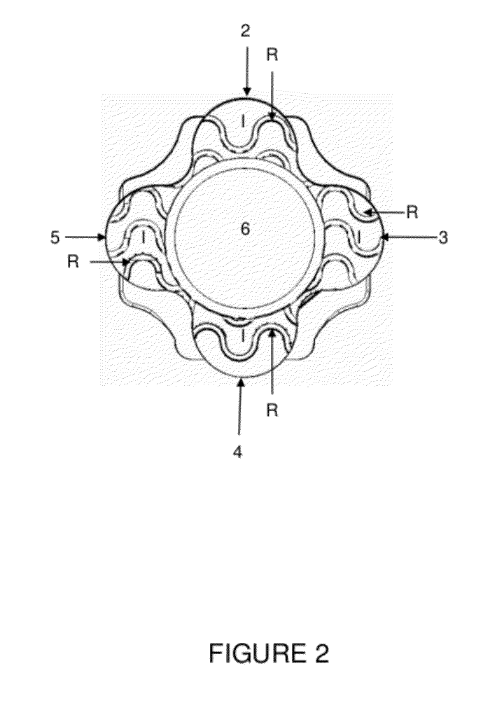

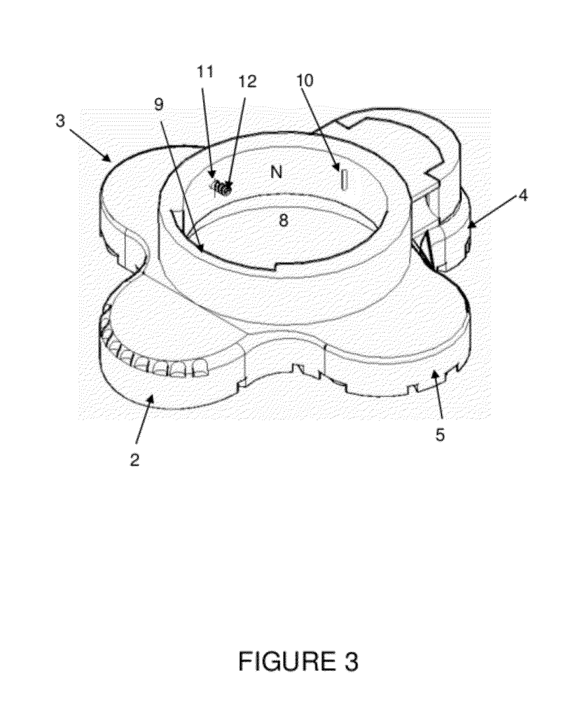

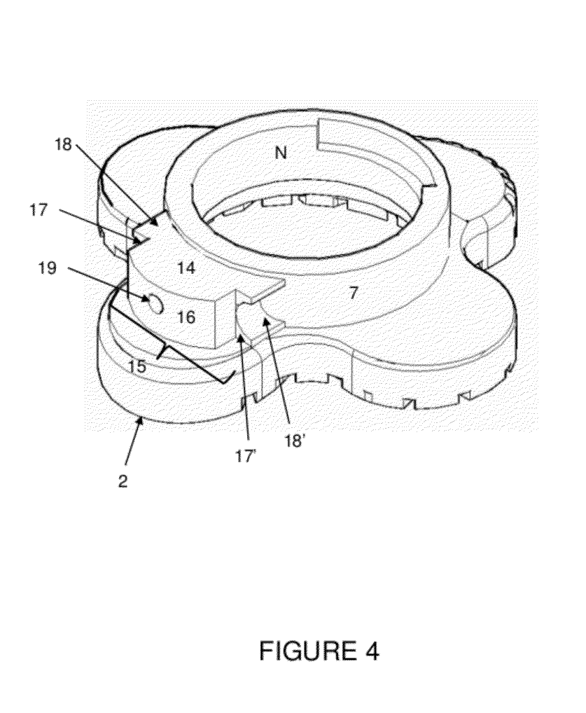

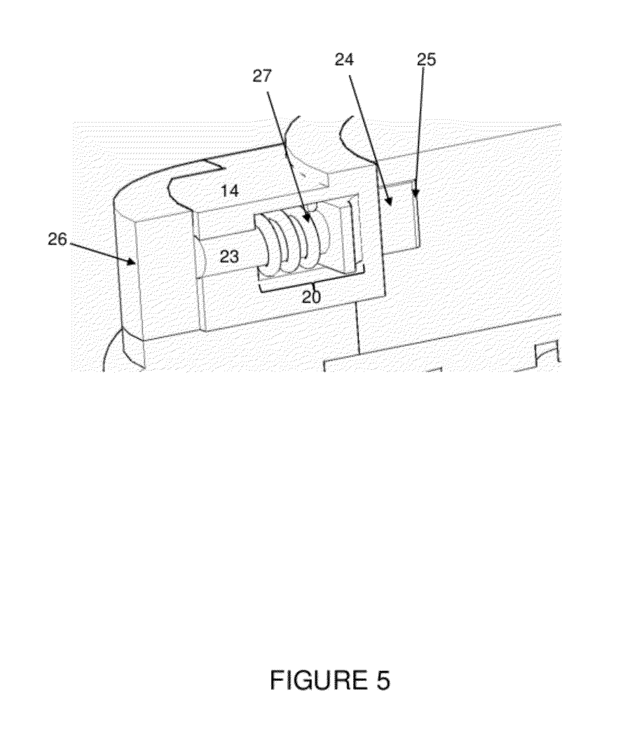

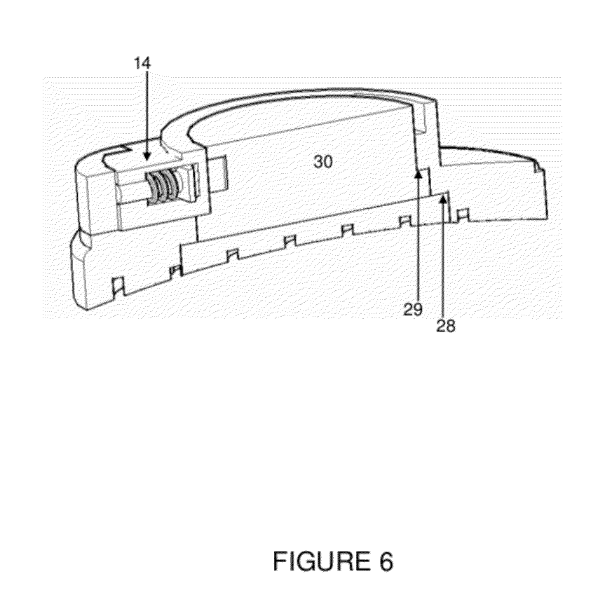

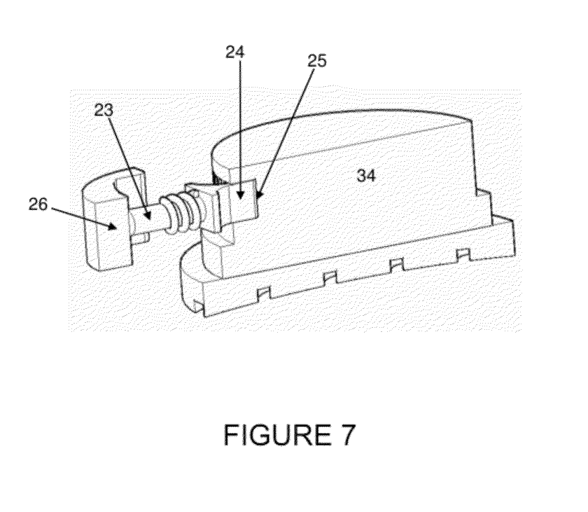

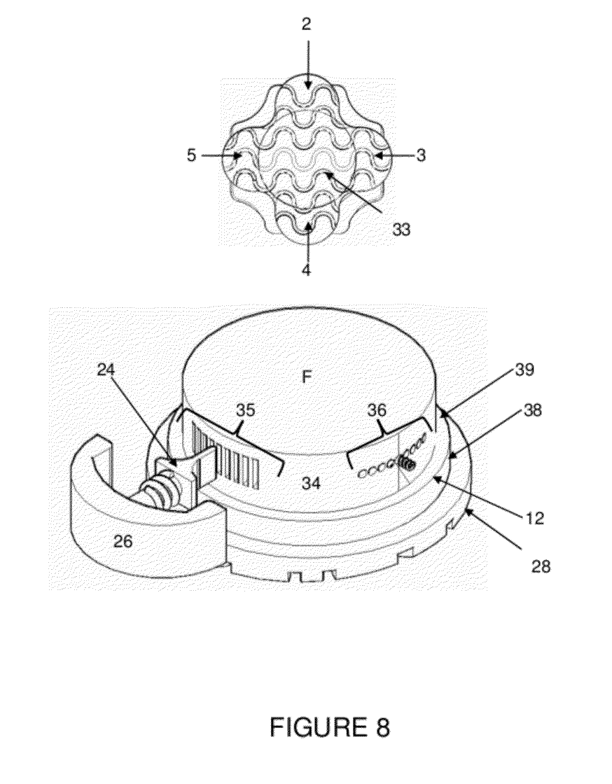

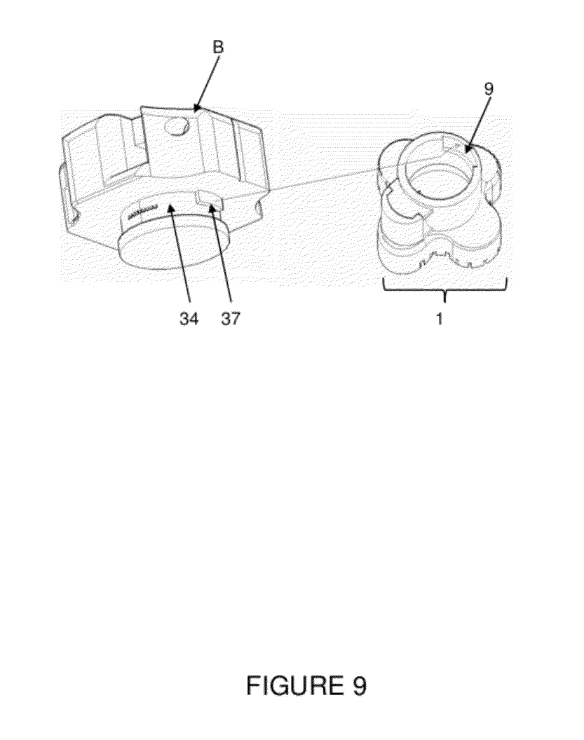

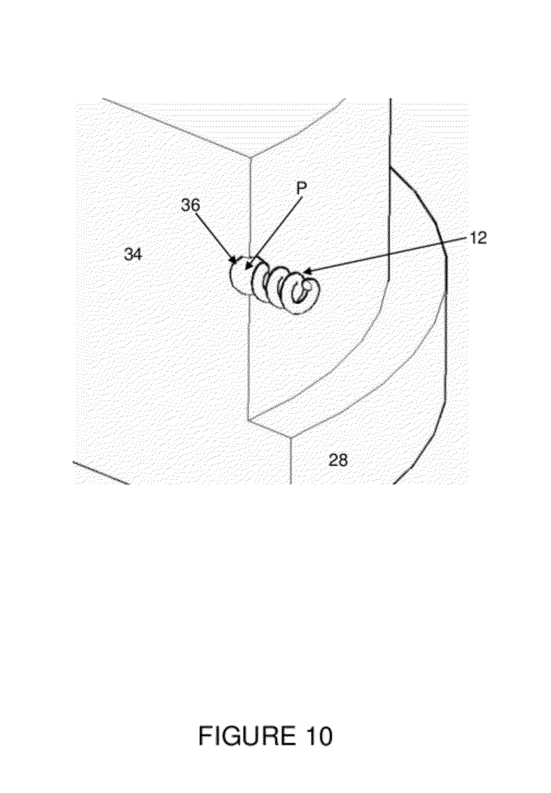

a circular support base 1 (FIGS. 1 and 2) for a bracket “B” (FIG. 8) comprising:
a first arm 2, a second arm 3, a third arm 4, and a fourth arm 5, each having its edges and ends rounded, equidistantly distributed around the circular base 1, and each element having a lower surface “I”, said lower surface “I” having a plurality of undulated grooves “R” for receiving an adhesive in order to be cemented onto the front side of the teeth;
a central circular aperture 6; and
a tubular member 7 integrally and centrally depending from the circular base 1 and having:
   an external surface “E” and an internal surface “N”, forming an internal housing 8;
   a semicircular cut 9 located at a superior end of the internal surface “N” of the tubular member 7 coinciding with the first arm 2 of the circular base 1;
   a rectangular passage 10 (FIG. 3), crossing the wall of the tubular member 7 and centrally coinciding with the third arm 4 of the circular base 1, opposed to the semicircular cut 9;
   a circular housing 11 opened to the internal cavity 8 and coinciding with the second arm 3 of the circular base 1 which is perpendicular to the first arm 2;
   a spring 12 housed inside the circular housing 11, raised over the internal surface “N” of the tubular member 7 and pushing a pellet “P (FIG. 9)”;
locking means 13 (FIGS. 4 and 5) comprising:
   a retention housing 14 having a volumetric “T” shape, depending from the external surface “E” of the tubular member 7 and mounted over the first arm 2, having a main frontal surface 15, formed by a front wall 16, and two lateral surfaces 17, 17′ having a “C” shape, formed by lateral walls having a “C” shape, 18, 18′, wherein the front wall 16 has a circular passage 19 at a central portion thereof and wherein the retention housing 14, has and an internal housing 20, for containing the stroke of a piston, and coinciding with the circular passage 19 and with the rectangular passage 10, opposed to the circular passage 19, opened to the internal surface “N” of the tubular member 7;
   a locking piston comprising: a shaft 23 having a first and a second end; an arrow shaped head 24 joined to the first end of the shaft, having a vertical rectangular shaped tip 25 and a “U” shaped pulling member 26 joined to the second end of the shaft 23;
   a spring 27 surrounding the shaft;
   wherein the arrow shaped head 24 moves inside the internal housing 20 of the retention housing 14 and the shaft 23 passes through the circular passage 19 to the outside of the retention housing 14;
   wherein the “U” shaped pulling member 26 is joined to the second end of the shaft 23 outside the retention housing 14;
   wherein the spring 27 that surrounds the shaft 23 pushes the arrow shaped head 24 in such way that the vertical rectangular shaped tip 25 completely passes through the rectangular passage 10 of the tubular member 7 and wherein the “U” shaped pulling member 26 is pulled towards the main frontal surface 15 of the retention housing 14, in such way that it rests on the main frontal surface 15 and on the two lateral surfaces 17, 17′;
a first circular step 28 (FIG. 6) formed by the circular base 1 and a second circular concentric step 29 having a lesser diameter, formed between the tubular member 7 and the circular base 1, both oriented in the same plane that the inferior surface “I” of the circular base 1;
a rotary base 30 (FIGS. 6 and 7) for a bracket comprising:
a cylindrical member comprising:
   an inferior base 32 having a lower surface 33 having a plurality of undulated grooves; and
   a cylindrical main body 34 depending from the inferior base 32 and having a lesser diameter that the inferior base 32 and having: a superior surface “F” for receiving a bracket “B” (FIG. 8); a plurality of rectangular shaped housings 35 equidistantly distributed around an arc portion of the cylindrical main body 34; and a plurality of circular shaped housings 36 equidistantly distributed around an arc portion of the cylindrical main body 34;
   a rectangular protrusion 37 (FIG. 8) located at a superior portion of the cylindrical main body 34, extending around an arc portion thereof;
   a first circular step 38 formed by the inferior main base 32 and the cylindrical main body 34, and a second circular concentric step 39 having a lesser diameter, formed by an inferior portion of the cylindrical main body 34;

wherein the rotary base 30 of the bracket is rotary housed inside the circular housing 11 of the tubular member 7 in such way that:
the first step 38 of the cylindrical member 31 is coupled with the first circular step 28 of the circular support base 1 and the second circular concentric step 39 of the cylindrical member 31 is coupled with the second circular concentric step 29 of the tubular member 7, thus avoiding the cylindrical member 31 to move upwards:
the rectangular shaped tip 25 of the arrow shaped head 24 passing through the rectangular passage 10 of the tubular member 7, coincides with one of the rectangular shaped housings 35 of the cylindrical main body 34 and is housed thereof when the spring 27 pushes the arrow shaped head 24, avoiding the rotation of the cylindrical member 31, thus locking the rotary base 30 (FIG. 10);
the spring 12 housed inside the circular housing of the tubular member and raised over the internal surface of the tubular member, pushes the pellet “P” into one of the coincident circular shaped housings 36 of the rotary base 30, where it is partially housed (FIG. 9); and
the rectangular protrusion 37 coincides with the semicircular cut 9 located at a superior end of the internal surface “N” of the tubular member 7, where it is able to slide and serve as a bump element to limit the rotational movement of the cylindrical member 31 between an angular range.

When it is necessary to rotate the bracket to fit the needs of the user, it is necessary to pull the pulling member 26 by means of any adequate tool in order to pull the locking piston's 22 arrow shaped head 24 and pull out the rectangular shaped tip 25 from the correspondent rectangular shaped housing 35 of the rotary base 30, thus compressing the spring 27 that surrounds the shaft 23 and that pushes the arrow shaped head 24;

Once the rotary base 30 is liberated, the bracket is rotated by means of an adequate tool, to a specific rotational position measured in degrees and correspondent to the position of each circular shaped housing and each rectangular shaped housing of the rotary base, so that the rectangular shaped tip 25 of the locking piston 22 always coincide with one of the rectangular shaped housings 35 which represents a specific rotational position.

When the rotary base 30 is rotated, the pellet “P” that is pushed by the spring 27 is forced out of a circular shaped housing 36 and forced to partially enter the next circular shaped housing 36, thus providing audible and tactile feedback to the user any time that the pellet “P” enters a circular shaped housing 36, thus indicating when the bracket is positioned at a specific rotational position.

Once the bracket is positioned at a specific rotational position, the tool liberates the pulling member 26, thus allowing the spring 27 to push the arrow shaped head 24 and that the rectangular shaped tip 25 enters a rectangular shaped housing 35 correspondent to said specific rotational position, thus locking the movement of the rotary base 30 in said specific rotational position.

The tool that may be used to rotate the bracket may comprise any adequate tool that can be able to pull and liberate the pulling member 26 and to rotate the bracket.

The bracket that may be mounted on the rotary base 30, may have any suitable design in accordance with the needed treatment

Finally it must be understood that the adjustable orthodontic bracket of the present invention, is not limited exclusively to the embodiments above described and illustrated and that the persons having ordinary skill in the art can, with the teaching provided by the invention, to make modifications to the adjustable orthodontic bracket of the present invention, which will clearly be within of the true inventive concept and of the scope of the invention which is claimed in the following claims.

1. An adjustable orthodontic bracket comprising:
a fixed support base having a circular housing and an inferior surface for attaching to the surface of a tooth;
a rotating base, rotary housed inside the circular housing, having a superior surface for receiving a bracket; and
locking means for the rotating base, for locking the rotary movement of the base at a specific rotational position, wherein said locking means can be disabled to allow the rotation of the rotating base.

2. An adjustable orthodontic bracket in accordance with claim 1, further comprising means for restricting the rotational movement of the rotating base between an angular range.

3. An adjustable orthodontic bracket in accordance with claim 1, wherein the fixed support base comprising:
a circular support base for a bracket comprising:
a first arm, a second arm, a third arm, and a fourth arm, each having its edges and ends rounded, equidistantly distributed around the circular base, and each element having a lower surface, said lower surface having a plurality of undulated grooves for receiving an adhesive in order to be cemented onto the front side of a teeth;
a central circular aperture; and
a tubular member integrally and centrally depending from the circular base.

4. An adjustable orthodontic bracket in accordance with claim 3, wherein the tubular member comprising:
an external surface and an internal surface, forming an internal housing;
a semicircular cut located at a superior end of the internal surface of the tubular member coinciding with the first arm of the circular base;
a rectangular passage, crossing the wall of the tubular member and centrally coinciding with the third arm of the circular base, opposed to the semicircular cut; and
a first circular step formed by the circular base and a second circular concentric step having a lesser diameter, formed between the tubular member and the circular base, both oriented in the same plane that the inferior surface of the circular base;
a circular housing opened to the internal cavity and coinciding with the second arm of the circular base which is perpendicular to the first arm; and
a spring housed inside the circular housing, raised over the internal surface of the tubular member and pushing a pellet.

5. An adjustable orthodontic bracket in accordance with claim 4, wherein the rotary base comprising:
a cylindrical member comprising:
an inferior base having a lower surface having a plurality of undulated grooves;
a cylindrical main body depending from the inferior base and having a lesser diameter that the inferior base; a plurality of rectangular shaped housings equidistantly distributed around an arc portion of the cylindrical main body; and a plurality of circular shaped housings equidistantly distributed around an arc portion of the cylindrical main body;
a rectangular protrusion located at a superior portion of the cylindrical main body, extending around an arc portion thereof;
a first circular step formed by the inferior main base and the cylindrical main body, and a second circular concentric step having a lesser diameter, formed by an inferior portion of the cylindrical main body;
wherein the rotary base of the bracket is rotary housed inside the circular housing of the tubular member in such way that:
the first step of the cylindrical member is coupled with the first circular step of the circular support base and the second circular concentric step of the cylindrical member is coupled with the second circular concentric step of the tubular member, thus avoiding the cylindrical member to move upwards:
the spring housed inside the circular housing of the tubular member and raised over the internal surface of the tubular member, pushes the pellet into one of the coincident circular shaped housings of the rotary base, where it is partially housed; and
the rectangular protrusion coincides with the semicircular cut located at a superior end of the internal surface of the tubular member, where it is able to slide and serve as a bump element to limit the rotational movement of the cylindrical member between an angular range

6. An adjustable orthodontic bracket in accordance with claim 1, wherein the locking means comprising a bolt slidable mounted over the fixed support base, said bolt entering one of a plurality of perforations in the rotating base for preventing the rotational movement of the rotating base.

7. An adjustable orthodontic bracket in accordance with claim 5 wherein the locking means comprising:
a retention housing having a volumetric “T” shape, depending from the external surface of the tubular member and mounted over the first arm, having a main frontal surface, formed by a front wall, and two lateral surfaces having a “C” shape, formed by lateral walls having a “C” shape, wherein the front wall has a circular passage at a central portion thereof and wherein the retention housing has and an internal housing for containing the stroke of a piston, and coinciding with the circular passage and with a rectangular passage, opposed to the circular passage opened to the internal surface of the tubular member;
a locking piston comprising: a shaft having a first and a second end; an arrow shaped head joined to the first end of the shaft, having a vertical rectangular shaped tip and a “U” shaped pulling member joined to the second end of the shaft;
a spring surrounding the shaft;
wherein the arrow shaped head moves inside the internal housing of the retention housing and the shaft passes through the circular passage to the outside of the retention housing;
wherein the “U” shaped pulling member is joined to the second end of the shaft outside the retention housing;
wherein the spring that surrounds the shaft pushes the arrow shaped head in such way that the vertical rectangular shaped tip completely passes through the rectangular passage of the tubular member and wherein the “U” shaped pulling member is pulled towards the main frontal surface of the retention housing, in such way that it rests on the main frontal surface and on the two lateral surfaces; and
the rectangular shaped tip of the arrow shaped head passing through the rectangular passage of the tubular member, coincides with one of the rectangular shaped housings of the cylindrical main body and is housed thereof when the spring pushes the arrow shaped head, avoiding the rotation of the cylindrical member, thus locking the rotary base.

8. An adjustable orthodontic bracket comprising:
a circular support base for a bracket comprising:
a first arm, a second arm, a third arm, and a fourth arm, each having its edges and ends rounded, equidistantly distributed around the circular base, and each element having a lower surface, said lower surface having a plurality of undulated grooves for receiving an adhesive in order to be cemented onto the front side of the teeth;
a central circular aperture; and
a tubular member integrally and centrally depending from the circular base and having:
an external surface and an internal surface, forming an internal housing;
a semicircular cut located at a superior end of the internal surface of the tubular member coinciding with the first arm of the circular base;
a rectangular passage, crossing the wall of the tubular member and centrally coinciding with the third arm of the circular base, opposed to the semicircular cut;
a circular housing opened to the internal cavity and coinciding with the second arm of the circular base which is perpendicular to the first arm;
a spring housed inside the circular housing, raised over the internal surface of the tubular member and pushing a pellet;
locking means comprising:
a retention housing having a volumetric shape, depending from the external surface of the tubular member and mounted over the first arm, having a main frontal surface, formed by a front wall, and two lateral surfaces having a “C” shape, formed by lateral walls having a “C” shape, wherein the front wall has a circular passage at a central portion thereof and wherein the retention housing, has and an internal housing, for containing the stroke of a piston, and coinciding with the circular passage and with a rectangular passage, opposed to the circular passage, opened to the internal surface “N” of the tubular member;
a locking piston comprising: a shaft having a first and a second end; an arrow shaped head joined to the first end of the shaft, having a vertical rectangular shaped tip and a “U” shaped pulling member joined to the second end of the shaft;
a spring surrounding the shaft;
wherein the arrow shaped head moves inside the internal housing of the retention housing and the shaft passes through the circular passage to the outside of the retention housing;
wherein the “U” shaped pulling member is joined to the second end of the shaft outside the retention housing;
wherein the spring that surrounds the shaft pushes the arrow shaped head in such way that the vertical rectangular shaped tip completely passes through the rectangular passage of the tubular member and wherein the “U” shaped pulling member is pulled towards the main frontal surface of the retention housing, in such way that it rests on the main frontal surface and on the two lateral surfaces;
a first circular step formed by the circular base and a second circular concentric step having a lesser diameter, formed between the tubular member and the circular base, both oriented in the same plane that the inferior surface of the circular base;
a rotary base for a bracket comprising:
a cylindrical member comprising:
an inferior base having a lower surface having a plurality of undulated grooves; and
a cylindrical main body depending from the inferior base and having a lesser diameter that the inferior base; a plurality of rectangular shaped housings equidistantly distributed around an arc portion of the cylindrical main body; and a plurality of circular shaped housings equidistantly distributed around an arc portion of the cylindrical main body;
a rectangular protrusion located at a superior portion of the cylindrical main body, extending around an arc portion thereof;
a first circular step formed by the inferior main base and the cylindrical main body, and a second circular concentric step having a lesser diameter, formed by an inferior portion of the cylindrical main body;
wherein the rotary base of the bracket is rotary housed inside the circular housing of the tubular member in such way that:
the first step of the cylindrical member is coupled with the first circular step of the circular support base and the second circular concentric step of the cylindrical member is coupled with the second circular concentric step of the tubular member, thus avoiding the cylindrical member to move upwards:
the rectangular shaped tip of the arrow shaped head passing through the rectangular passage of the tubular member, coincides with one of the rectangular shaped housings of the cylindrical main body and is housed thereof when the spring pushes the arrow shaped head, avoiding the rotation of the cylindrical member, thus locking the rotary base;
the spring housed inside the circular housing of the tubular member and raised over the internal surface of the tubular member, pushes the pellet into one of the coincident circular shaped housings of the rotary base, where it is partially housed; and
the rectangular protrusion coincides with the semicircular cut located at a superior end of the internal surface of the tubular member, where it is able to slide and serve as a bump element to limit the rotational movement of the cylindrical member between an angular range.
